(19) United States
(12) Patent Application Publication
(10) Pub. No.: US 2023/0237014 A1
(43) Pub. Date: Jul. 27, 2023

(54) 3D Convolutional Neural Network (CNN) Implementation on Systolic Array-Based FPGA Overlay CNN Accelerator

(71) Applicant: Intel Corporation, Santa Clara, CA (US)

(72) Inventors: Jin Hee Kim, Toronto (CA); Mohamed Bahaaeldin Mohamed Eldafrawy, Toronto (CA); Thanoshan Ariyanayagam, Toronto (CA); Andrew Ronald Rooney, Toronto (CA)

(21) Appl. No.: 18/129,341

(22) Filed: Mar. 31, 2023

(51) Int. Cl. G06F 15/80

(52) U.S. Cl. CPC G06F 15/8046; G06F 9/5027

(57) ABSTRACT

Integrated circuit devices, methods, and circuitry are provided for enabling FPGA-based two-dimensional (2D) systolic array CNN accelerators to operate on three-dimensional (3D) input data having an extra dimension in temporal or spatial dimension. Technology, methods, and circuity for three-dimensional (3D) convolution, 3D folding, and 3D pooling are provided for the 3D CNN accelerators. A depth counter is provided to feed 3D input data and filter data through the 2D CNN accelerator to produce a 3D CNN accelerator that can efficiently operate on 3D input data.

### BACKGROUND

This disclosure relates to circuitry to efficiently implement a convolutional neural network (CNN) to operate on three-dimensional (3D) data sets.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Neural network systems have gained widespread use in many computing problems, such as classification and recognition (e.g., image recognition, natural language processing). One of the most widely used deep learning systems is convolutional neural network (CNN). A CNN usually involves time consuming computations; therefore, many neural network accelerators have been designed to accelerate the process of computations in the CNN (e.g., the convolutional computation). Many integrated circuits include arithmetic circuit blocks to perform arithmetic operations such as addition and multiplication. Programmable logic circuitry and digital signal processing (DSP) blocks may be used to perform numerous different arithmetic functions. For example, a digital signal processing (DSP) block may supplement programmable logic circuitry in a programmable logic device, such as a field programmable gate array (FPGA). The field programmable gate array (FPGA) can combine computing, logic, and memory resources in a single programmable logic device. Due to the parallel processing capability, low power consumption, and reprogrammable ability of FPGAs, FPGA accelerators may be used for implementing CNNs.

Convolutional neural networks (CNNs) are made up of neurons that have learnable weights and biases. Each neuron receives some inputs and performs a dot product. Existing FPGA-based CNN accelerators are designed specifically for two-dimensional (2D) neural networks, in which inputs contain objects with only two dimensions (e.g., X and Y coordinates), such as images, spectrograms, or other 2D signals. Many existing accelerator implementations are restricted to performing 2D convolutions, making them incapable of running on three-dimensional (3D) input data having an extra dimension beyond 2D input data, such as video-specific tasks (e.g., human actions, videos) having an extra temporal dimension, or computerized tomography (CT) scans having an extra spatial dimension (e.g., Z coordinate) in the three-dimensional (3D) Cartesian coordinate system.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of this disclosure may be better understood upon reading the following detailed description and upon reference to the drawings in which:

FIG. 1 is a block diagram of a system used to program an integrated circuit device;

FIG. 2 is a block diagram of the integrated circuit device of FIG. 1;

FIG. 3 is a block diagram of an example architecture that may be used in a 3D CNN implementation on the integrated circuit device;

FIG. 4 is a block diagram of an example of a 3D convolution layer;

FIG. 5 is a flowchart of a method for performing a 3D convolution using CNN acceleration circuitry;

FIG. 6 is a block diagram of an example of a circuit that may be used to perform the 3D convolution of FIG. 5;

FIG. 7 is a block diagram illustrating a 3D convolution operation;

FIG. 8 is a block diagram of an example of 3D folding to more efficiently use the CNN acceleration circuitry;

FIG. 9 is an example of a 3D pooling operation; and

FIG. 10 is a block diagram of a data processing system that may incorporate the integrated circuit.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

A Convolutional neural network (CNN) may include an input layer, one or more hidden layers, and an output layer. The basic unit of computation in a neural network is the neuron/node. Each neuron/node receives input from some other nodes, or from an external source and computes an output. The input layer may include neurons/nodes to receive external inputs, such as input data to the CNN. Each hidden layer is made up of a set of neurons/nodes that have learnable weights and biases, and each neuron/node in the hidden layers may receive some inputs and perform a dot product. The output layer may include neurons/nodes to receive inputs from the hidden layers and output results of the CNN. This disclosure describes a system and method enabling FPGA-based two-dimensional (2D) systolic array CNN accelerators to operate on three-dimensional (3D) input data, such as video-specific tasks (e.g., human actions, videos) having an extra temporal dimension, or computerized tomography (CT) scans having an extra spatial dimension (e.g., Z coordinate) in the three-dimensional (3D) Cartesian coordinate system (e.g., X coordinate, Y coordinate, Z coordinate). Including a depth counter to feed 3D input data and 3D filter data through the 2D CNN accelerator produces a 3D CNN accelerator that can efficiently operate on 3D input data.

A CNN uses a feedforward artificial network of neurons to execute image identification or recognition. It uses a reverse feed system for learning and produces a set of weights to calibrate the execution system. A CNN may include multiple layers in the hidden layers, such as convolution layers, pooling layers, and activation layers. The convolution layer extracts low-level features (e.g., lines or edges within an image) from the input data, and the pooling layer reduces variations (e.g., by maxing or value averaging, pooling common features over a particular region of an image). The result may be passed on to further convolution and pooling layers. The number of CNN layers correlates to the accuracy of the CNN. These layers may operate independently and may be used in a data pipeline, in which data are passed from one layer to another. The processing system may use external memory to buffer the data between each layer. The compiler and intellectual property (IP) in a 3D CNN, which contains 3D layers such as 3D convolution layers, 3D pooling layers, and 3D activation layers, support the additional dimension in feature and filter data.

This solution benefits from many innovations, including:
1. 3D convolution—depth counters are added to the feature/filter readers and writers in the on-chip buffers and memory devices to account for the additional dimensions, and the processing element (PE) array is fed without writing out partial sums. By using the depth counters, the filters do not need to be reloaded multiple times, and the output feature maps can be completed before writing back the filters to the on-chip buffers or memory devices.
2. 3D folding—folding is applied to the convolution layer (e.g., the first convolution layer) to improve the performance and utilization of the PE array. Inputs to CNNs often have multiple channels (e.g., red (R), green (G), blue (B)), and a vectorization channel is generally used to vectorize input data for vector operations. In the case the vectorization channel is larger than the channels of the input data, the input data may be reshaped by leveraging the filter stride, so that some of the depth, height, or width data are moved into the vectorization channel. Thus, a volume of the input data may be folded into the vectorization channel, and the PE array is better utilized.
3. 3D pooling—the 3D average pooling is converted into a 3D convolution, and the 3D max pooling is decomposed into two 2D max pooling, a surface pooling followed by a depth pooling. The compiler is modified to decompose the 3D maxing pooling to a 2D max pooling and a depth max pooling. Thus, the 3D pooling layer is decomposed to a 2D pooling layer and a depth pooling layer in the compiler, in which the depth is mapped as width to allow the reuse of existing 2D pooling module.

Accordingly, the 3D CNN accelerator circuitry of this disclosure enables implementing an FPGA-based two-dimensional (2D) systolic array CNN accelerator to operate on three-dimensional (3D) input data and avoiding significant hardware cost. The 3D input data may include video-specific tasks (e.g., human action, video) having an extra temporal dimension, or computerized tomography (CT) scans having an extra spatial dimension (e.g., Z coordinate) in the three-dimensional (3D) Cartesian coordinate system.

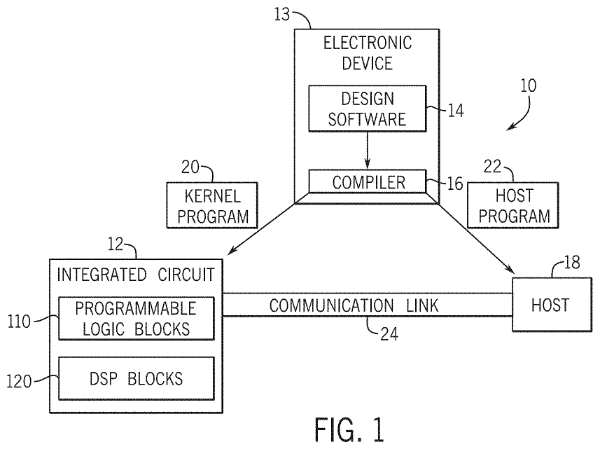

FIG. 1 illustrates a block diagram of a system 10 that may be used to implement the 3D CNN of this disclosure on an integrated circuit system 12 (e.g., a single monolithic integrated circuit or a multi-die system of integrated circuits). A designer may desire to implement the 3D CNN on the integrated circuit system 12 (e.g., a programmable logic device such as a field-programmable gate array (FPGA) or an application-specific integrated circuit (ASIC) that includes programmable logic circuitry). The integrated circuit system 12 may include a single integrated circuit, multiple integrated circuits in a package, or multiple integrated circuits in multiple packages communicating remotely (e.g., via wires or traces). In some cases, the designer may specify a high-level program to be implemented, such as an OPENCL® program that may enable the designer to more efficiently and easily provide programming instructions to configure a set of programmable logic cells for the integrated circuit system 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit system 12.

In a configuration mode of the integrated circuit system 12, a designer may use an electronic device 13 (e.g., a computer) to implement high-level designs (e.g., a system user design) using design software 14, such as a version of INTEL® QUARTUS® by INTEL CORPORATION. The electronic device 13 may use the design software 14 and a compiler 16 to convert the high-level program into a lower-level description (e.g., a configuration program, a bitstream). The compiler 16 may provide machine-readable instructions representative of the high-level program to a host 18 and the integrated circuit system 12. The host 18 may receive a host program 22 that may control or be implemented by the kernel programs 20. To implement the host program 22, the host 18 may communicate instructions from the host program 22 to the integrated circuit system 12 via a communications link 24 that may include, for example, direct memory access (DMA) communications or peripheral component interconnect express (PCIe) communications. In some embodiments, the kernel programs 20 and the host 18 may configure programmable logic blocks 110 on the integrated circuit system 12. The programmable logic blocks 110 may include circuitry and/or other logic elements and may be configurable to implement a variety of functions in combination with digital signal processing (DSP) blocks 120.

The designer may use the design software 14 to generate and/or to specify a low-level program, such as the low-level hardware description languages described above. Further, in some embodiments, the system 10 may be implemented without a separate host program 22. Thus, embodiments described herein are intended to be illustrative and not limiting.

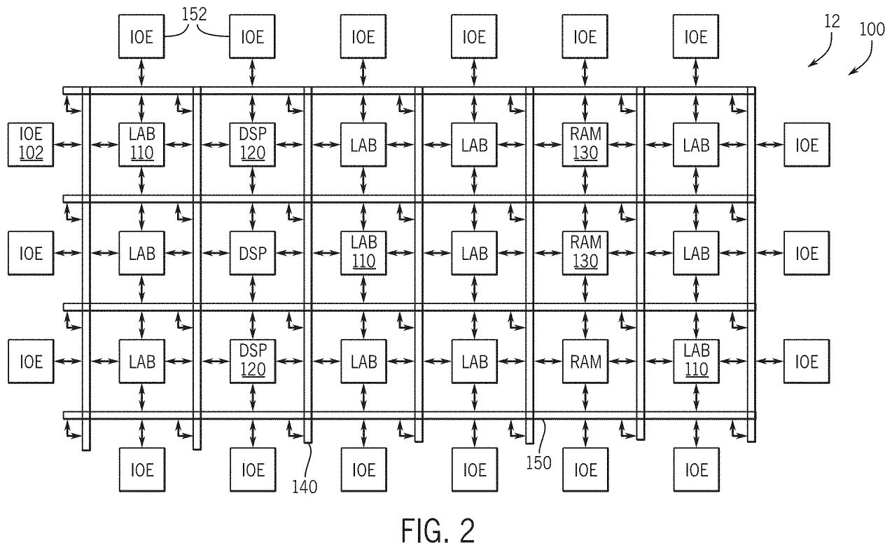

An illustrative embodiment of a programmable integrated circuit system 12 such as a programmable logic device (PLD) 100 that may be configured to implement a circuit design is shown in FIG. 2. As shown in FIG. 2, the integrated circuit system 12 (e.g., a field-programmable gate array (FPGA) integrated circuit) may include a two-dimensional array of functional blocks, including programmable logic blocks 110 (also referred to as logic array blocks (LABs) or configurable logic blocks (CLBs)) and other functional blocks, such as embedded digital signal processing (DSP) blocks 120 and embedded random-access memory (RAM) blocks 130, for example. Functional blocks such as LAB s 110 may include smaller programmable regions (e.g., logic elements, configurable logic blocks, or adaptive logic modules) that receive input signals and perform custom functions on the input signals to produce output signals. LABs 110 may also be grouped into larger programmable regions sometimes referred to as logic sectors that are individually managed and configured by corresponding logic sector managers. The grouping of the programmable logic resources on the integrated circuit system 12 into logic sectors, logic array blocks, logic elements, or adaptive logic modules is merely illustrative. In general, the integrated circuit system 12 may include functional logic blocks of any suitable size and type, which may be organized in accordance with any suitable logic resource hierarchy.

Programmable logic the integrated circuit system 12 may contain programmable memory elements. Memory elements may be loaded with configuration data (also called programming data or configuration bitstream) using input-output elements (IOEs) 152. Once loaded, the memory elements each provide a corresponding static control signal that controls the operation of an associated functional block (e.g., LABs 110, DSP 120, RAM 130, or input-output elements 152).

In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory, configuration random-access memory (CRAM), or programmable memory elements. Programmable logic device (PLD) 100 may be configured to implement a custom circuit design. For example, the configuration RAM may be programmed such that LABs 110, DSP 120, and RAM 130, programmable interconnect circuitry (i.e., vertical channels 140 and horizontal channels 150), and the input-output elements 152 form the circuit design implementation.

In addition, the programmable logic device may have input-output elements (IOEs) 152 for driving signals off the integrated circuit system 12 and for receiving signals from other devices. Input-output elements 152 may include parallel input-output circuitry, serial data transceiver circuitry, differential receiver and transmitter circuitry, or other circuitry used to connect one integrated circuit to another integrated circuit.

The integrated circuit system 12 may also include programmable interconnect circuitry in the form of vertical routing channels 140 (i.e., interconnects formed along a vertical axis of the programmable logic device (PLD) 100) and horizontal routing channels 150 (i.e., interconnects formed along a horizontal axis of the programmable logic device (PLD) 100), each routing channel including at least one track to route at least one wire. If desired, the interconnect circuitry may include pipeline elements, and the contents stored in these pipeline elements may be accessed during operation. For example, a programming circuit may provide read and write access to a pipeline element.

Note that other routing topologies, besides the topology of the interconnect circuitry depicted in FIG. 1, are intended to be included within the scope of the present disclosure. For example, the routing topology may include wires that travel diagonally or that travel horizontally and vertically along different parts of their extent as well as wires that are perpendicular to the device plane in the case of three-dimensional integrated circuits, and the driver of a wire may be located at a different point than one end of a wire. The routing topology may include global wires that span substantially all of the integrated circuit system 12, fractional global wires such as wires that span part of the integrated circuit system 12, staggered wires of a particular length, smaller local wires, or any other suitable interconnection resource arrangement.

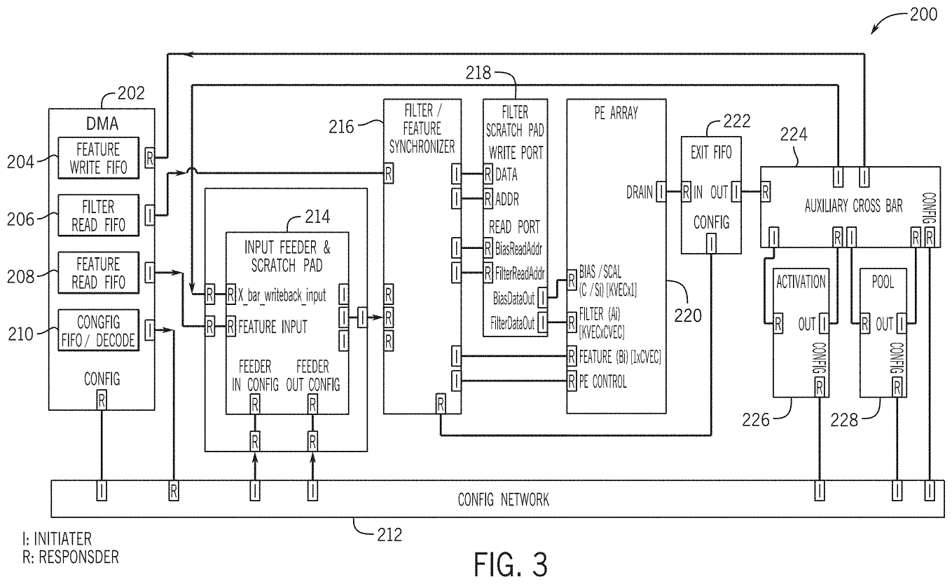

The integrated circuit system 12 may be programmed to perform a wide variety of operations, including implementing the 3D CNN accelerator circuitry of this disclosure. As mentioned above, FPGA-based CNN accelerators are often designed for 2D networks. This disclosure describes a system and method enabling FPGA-based two-dimensional (2D) systolic array CNN accelerators to operate on three-dimensional (3D) input data, such as video-specific tasks (e.g., human actions, videos) having an extra temporal dimension, or computerized tomography (CT) scans having an extra spatial dimension (e.g., Z coordinate) in the three-dimensional (3D) Cartesian coordinate system (e.g., X coordinate, Y coordinate, Z coordinate). An architecture 200 that may be used to support this implementation is shown in FIG. 3. As shown in FIG. 3, the architecture 200 includes a direct memory access (DMA) interface 202, which may include a feature write first in first out (FIFO) buffer 204, a filter reader FIFO 206, a feature reader FIFO 208, and a configuration FIFO/decoder 210. The DMA interface 202 may receive configuration data from a configuration network 212 and send configuration data to the configuration network 212 via the configuration FIFO/decoder 210. The feature reader FIFO 208 may send feature data to an input feeder and scratch pad 214, and the filter reader FIFO 206 may send filter data to a filter/feature synchronizer 216. The feature data include features that may be recognized or classified by the CNN. The input feeder and scratch pad 214 may receive configuration data (e.g., feeder in configuration and feeder out configuration) from the configuration network 212.

The input feeder and scratch pad 214 may send feature data to the filter/feature synchronizer 216, where the filter data and the feature data are synchronized. The filter/feature synchronizer 216 may send bias data address and filter data address to a read port in a filter scratch pad 218 to initiate filter/bias data, and the filter scratch pad 218 may read the bias data and the filter data from corresponding addresses and send them to a processing element (PE) array 220. The filter scratch pad 218 may also receive data and address information from the filter/feature synchronizer 216 to update the data in the scratch pad buffer via a write port in the filter scratch pad 218. The filter/feature synchronizer 216 may send the feature data and control signals to the PE array 220. The PE array 220 may process the convolution using the feature data and the filter data, and the results may be output to an exit FIFO 222, which may send the results to an auxiliary crossbar 224. The auxiliary crossbar 224 may implement an activation block 226 and a pool block 228 to process the results. The activation block 226 may apply activation functions (e.g., rectified linear unit (ReLU) function, sigmoid function, tanh function) to the results received from the auxiliary crossbar 224 and send the output back to the auxiliary crossbar 224. The pool block 228 may apply pooling layers to the results received from the auxiliary crossbar 224 to reduce variations (e.g., by maxing or value averaging, pooling common features over a particular region of an image) and send the output back to the auxiliary crossbar 224. The auxiliary crossbar 224, the activation block 226, and the pool block 228 may receive configuration data from the configuration network 212. The auxiliary crossbar 224 may send the processed feature results to the feature write FIFO 204 in the DMA 202, which may write the processed feature results to memory devices. The auxiliary crossbar 224 may also send the processed feature results to the input feeder and scratch pad 214 as feedbacks.

As described above, the architecture 200 shows data flow from the DMA interface 202 to the convolution engine, which includes the input feeder and scratch pad 214, the filter/feature synchronizer 216, the filter scratch pad 218, the PE array 220, and the exit FIFO 222. It should be noted that the circuits and blocks in the architecture 200 illustrated in FIG. 3 is an example, in other embodiments, the architecture 200 may be configured (e.g., bus widths, auxiliary functions) to support varying performance and area requirements. For example, to support 3D CNN implementation, additional counters may be added to the DMA 202 or the input feeder or scratch pad 214 to account for the additional dimension (e.g., depth), and the configuration network 212 includes corresponding configuration parameters (e.g., to initialize the counters associated with depth) for the additional counters in the DMA 202 or the input feeder or the scratch pad 214. Moreover, the feature reader FIFO 208, the feature writer FIFO 204, and the filter reader FIFO 206 may have additional pipeline stages to account for generating depth in filter and feature addresses. In addition, the data stored in the memory devices and the FIFO buffers may be organized in a format to include the additional dimension (e.g., depth). Accordingly, changes may be made in the compiler 16 to consider the additional dimension, such as address offsets, buffer allocations, padding, etc.

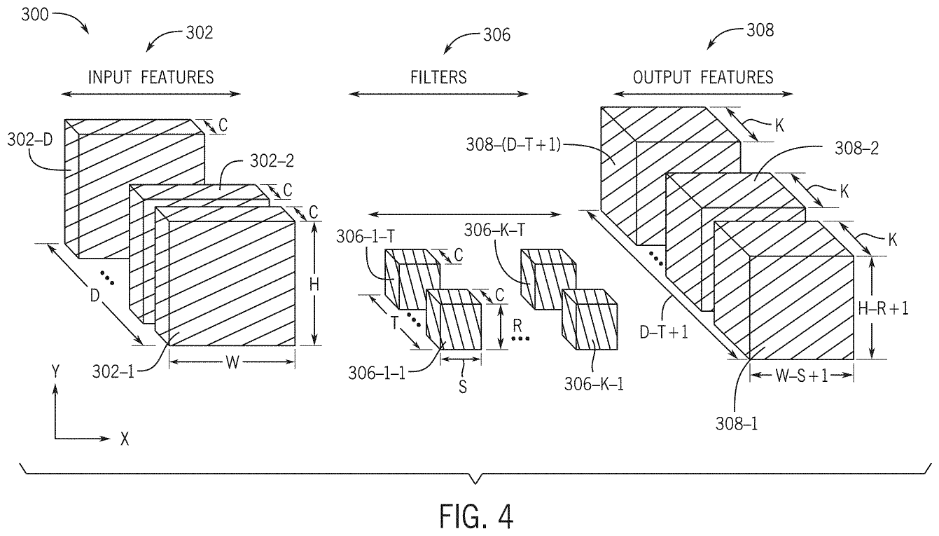

FIG. 4 is a block diagram illustrating a 3D convolution layer 300. Input data 302 of the convolution layer 300 may include multiple frames along a direction of depth D, such as a frame 302-1, a frame 302-2 . . . , and a frame 302-D (D is the maximum number of frames inside the input data 302). Each frame of the input data 302 has a width W (e.g., along X-axis), height H (e.g., along Y-axis), and a set of channels C. The set of channels C is often associated with color channels of the corresponding frame, such as red channel (R), green channel (G), and blue channel (B). The depth D may be along a temporal dimension or an extra spatial dimension perpendicular to XY plane (e.g., Z-axis). Accordingly, the input data 302 include a four-dimensional (4D) tensor (C×D×H×W). A 3D filter 306 may be used to filter the input data 302, and the 3D filter 306 strides in the directions of the width W, the height H, and the depth D. The 3D filter 306 may include K kernels with depth T, which is along the depth D direction, for example, kernel 306-1, kernel 306-2, kernel 306-K. T may be any number that is not greater than D. The 3D filter 306 may include filters with the same shape, for example, each filter may have a width S (e.g., along X-axis), height R (e.g., along Y-axis), and the set of channels C. Each kernel of the 3D filter 360 may include T component kernels. For example, at depth T=1, the kernel 306-1 may have a component kernel 306-1-1, and at depth T, the kernel 306-1 may have a component kernel 306-1-T. The component kernels in the 3D filter 306 may have the same number of channels C as the input data 302. For example, the component kernels may have the same color channels RGB as the input data 302. Accordingly, the 3D filter 306 may stride not only along the direction of width W and the direction of height H on the XY plane, but also along the direction of depth D. Therefore, the kernel operation in the convolution layer 300 is a 3D convolution in three dimensions.

In FIG. 4, the stride size of the 3D filter 306 along each dimension (e.g., W, H, D) is 1. The output data 308 includes (D−T+1) frames along the depth direction, such as a frame 308-1, a frame 308-2 . . . , and a frame 308-(D−T+1). Each frame of the output data 308 has a width (W−S+1) (e.g., along X-axis), height (H−R+1) (e.g., along Y-axis), and K channels along the channel dimension of the output data 308 (e.g., D−T+1). Each channel of the K channels corresponds to the corresponding output from one of the K kernels. Accordingly, the convolution layer 300 supports operations to 3D input data having an extra dimension, such as video-specific tasks (e.g., human actions, videos) having an extra temporal dimension, or computerized tomography (CT) scans having an extra spatial dimension (e.g., Z coordinate) in the three-dimensional (3D) Cartesian coordinate system.

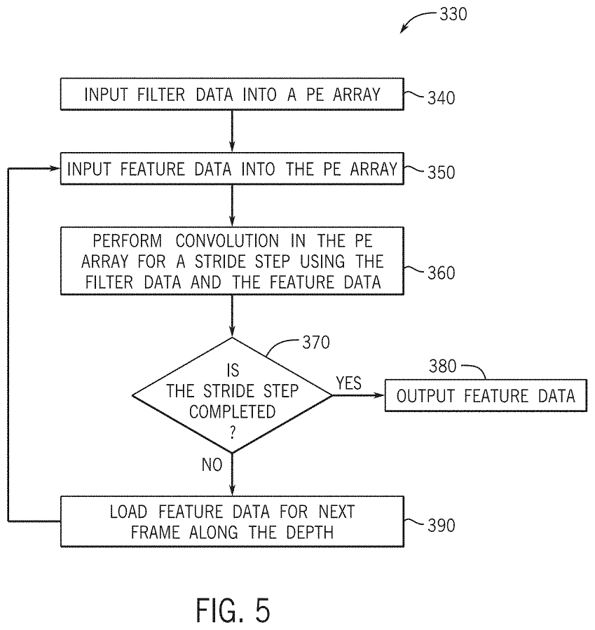

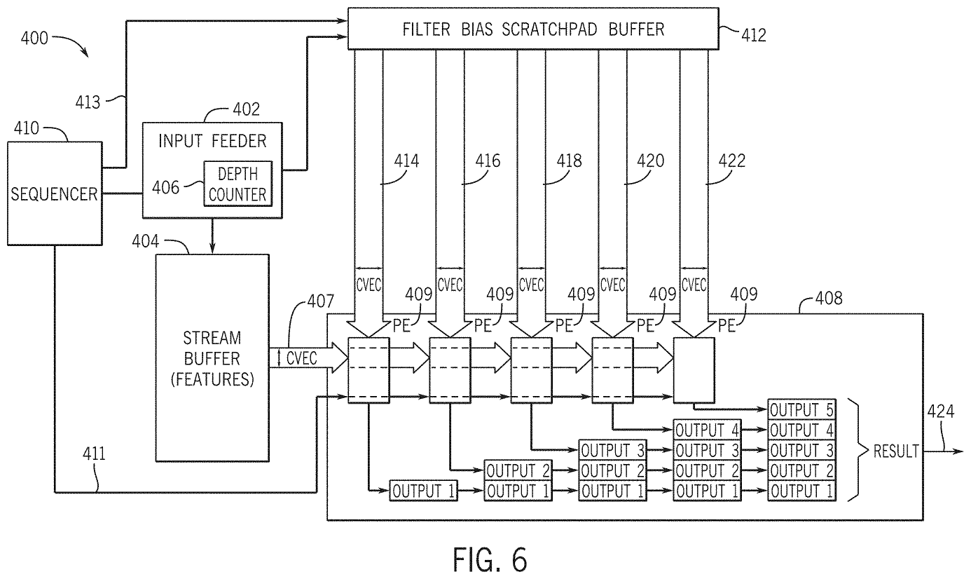

FIG. 5 shows a flowchart of a method 330 for performing the 3D convolution described above in FIG. 4. At block 340, filter data (e.g., filters in the 3D kernel 306) may be input into a processing element (PE) array (e.g., the PE array 220) from on-chip buffers or memory devices. At block 350, a set of feature data (e.g., 302-1 of the input data 302) may be input into the PE array (e.g., the PE array 220). At block 360, the PE array performs convolution for a stride (e.g., along dimension W, H, or D) of the filters (e.g., filters in the 3D kernel 306) using the filter data and the feature data input at block 350. At block 370, a determination may be made (e.g., by a sequencer shown in FIG. 6) about whether the stride is completed. If the stride is completed, the PE array may output the feature data (e.g., to the auxiliary crossbar 224) at block 380. If the stride is not completed, feature data for next frame along the depth of the input data (e.g., 302-2 of the input data 302) may be loaded (e.g., from the input feeder and scratch pad 214) at block 390, and a depth counter may be used to support the loading of the feature data. Then the loaded feature data may be input into the PE array (e.g., the PE array 220), and the steps in blocks 350 to 390 may be repeated until the stride is completed, and the PE array may output the feature data. In the method 330 described above, all the filter data may be input into the PE array at block 340 for the stride of the convolution, accordingly, utilizing the depth counter may help reduce or avoid reloading the filters multiple times and support feeding the PE array without writing out partial sums. Therefore, the output feature data may be completed before writing the filters back to the on-chip buffer or memory devices. In some embodiments, only part of the filter data may be input into the PE array at block 340 for the stride of the convolution, and the additional filter data for next frame along the depth of the filter data may be loaded (e.g., from the input feeder and scratch pad 214), and a depth counter may be used to support the loading of the filter data.

FIG. 6 is a schematic diagram of an example of a convolution engine 400 that may be used in the architecture 200 to perform the convolution described in FIG. 5. The convolution engine 400 may include an input feeder 402 to input filter data and feature data. The input feeder 402 may send feature data to a stream buffer 404. The input feeder 402 may include a depth counter 406 to support loading feature data or filter data along a depth dimension (e.g., depth D, depth T). The stream buffer 404 may send a set of feature data 407 to an overlay-configurable processing element (PE) array 408 to execute the convolution operation. The depth counter 406 may be used to account for the additional dimension (e.g., depth) to support feeding additional feature data and filter data to the PE array 408 for processing. For example, a frame at a first depth (e.g., along depth D) of the feature data may be input into the PE array 408 for processing with a number of filters at a first depth (e.g., along depth T) of the filter data at a first time, and a frame at a second depth (e.g., along D) of the feature data may be fed to the PE array 408 for processing with the same number of filters at the first depth (e.g., along depth T) of the filter data at a second time. Alternatively, the frame at the second depth (e.g., along D) of the feature data may be fed to the PE array 408 for processing with a number of filters at a second depth (e.g., along depth T) of the filter data at a second time. In both cases, the depth counter 406 may provide the information of the depth. Accordingly, utilizing the depth counter 406 may help reduce or avoid reloading the filters multiple times and/or support feeding the PE array without writing out partial sums.

The PE array 408 may include multiple PEs 409 (e.g., five). Since deep learning is extremely compute-hungry, it is beneficial to make the PE array 408 suitable for parallel computing. Therefore, vectorization may be used to convert sequential data (e.g., feature data or filter data along the depth) into a vector implementation, so that multiple PEs 409 may be used to process data simultaneously in the PE array 408. For example, the PE array 408 may include an accumulator having a set of dot-product-accumulate modules and may be able to process a convolution operation by accumulating dot product results of Cvec, which is an overlay parameter for the feature data, elements of feature data (e.g., images, video) with a number of Kvec, which is an overlay parameter for the filters, filters simultaneously. The particular number Cvec indicates the vectorization along the channels of the input feature data and/or filter data, and the number Kvec is a number of PEs 409 in the PE array 408 that allow multiple filters to be applied to the feature data simultaneously. For example, in FIG. 6, the PE array 408 includes five PEs 409, and the Kvec has a value of five. The result of each dot product is added to the running sum in the accumulator of each PE 409 in the PE array 408 until a sequencer 410 send out a flushing signal. The flushing signal is used to indicate an end of a stride (e.g., along W, H, or D) of the filters in the 3D kernel (e.g., the 3D kernel 306), when the running sum in each accumulator corresponds to an output feature.

In FIG. 6, the sequencer 410 is coupled to the input feeder 402 to transfer a sequence signal 411 to the PEs 409. The sequencer 410 may send out a flushing signal when the sequence signal 411 indicates that a stride is completed in the PE array 408. The input feeder 402 may send filter data to a filter bias scratchpad buffer 412, which may send multiple filters (e.g., five) to the PE array 408. The sequencer 410 may transfer a sequence signal 413 to the filter bias scratchpad buffer 412. In the embodiment illustrated in FIG. 6, each of five filters 414, 416, 418, 420, and 422 has a corresponding Cvec wide data bus and is sent to a respective PE 409 in the PE array 408. The feature data 407 move horizontally in the corresponding Cvec wide data bus through the PEs 409 inside the PE array 408 with the sequence signal 411 for processing with each filter (e.g., the filter 414, the filter 416, the filter 418, the filter 420, the filter 422). The filter data in the filter data buses are delayed according to the sequence signal 413 so that the filter data arrive at the corresponding PE at the same time as the feature data. The filter data and the feature data are processed by the PEs 409, and the corresponding outputs (e.g., output 1 corresponding to the filter 414, output 2 corresponding to the filter 416, output 3 corresponding to the filter 418, output 4 corresponding to the filter 420, and output 5 corresponding to the filter 422) are concatenated in the result 424 and may be sent to the auxiliary crossbar 224. In some embodiments, the feature data may be sent to PEs 409 in a parallel manner (rather than the serial manner shown in FIG. 6) so that the feature data may not move horizontally through all PEs 409 in the PE array 408, instead, the feature data may be transferred to each PE 409 in the PE array 408 separately.

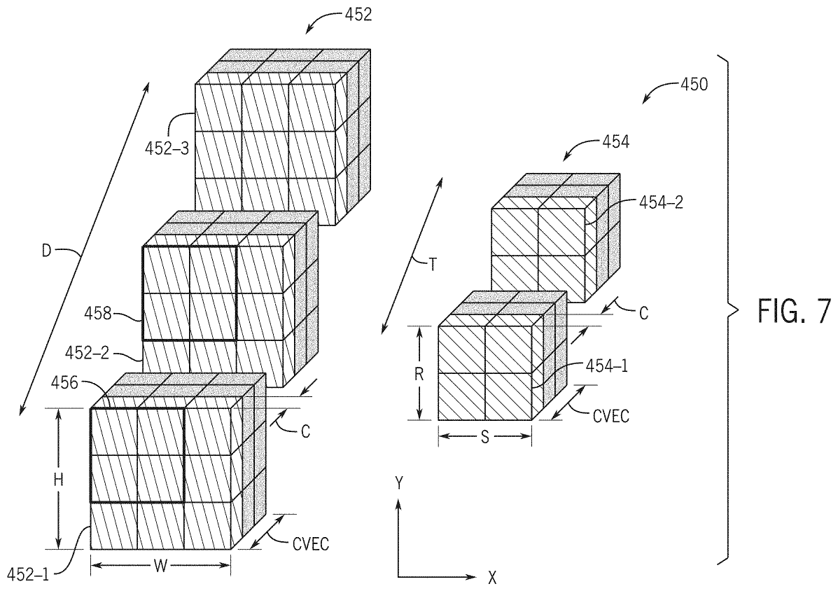

FIG. 7 is a block diagram of an example of a 3D convolution operation 450 having parameters Cvec=3 and Kvec=1. In FIG. 7, one PE may be used in the convolution operation 450. The convolution 450 may include input data 452 and a 3D filter 454. Each frame of the input data 452 has a width W (e.g., along X-axis), height H (e.g., along Y-axis), and a set of channels C. The channels C are often associated with color channels of the corresponding frame, such as red channel (R), green channel (G), and blue channel (B). The input data 452 has an additional depth D, which may be along a temporal dimension or an extra spatial dimension perpendicular to XY plane (e.g., Z-axis). Accordingly, the input data 452 include a four-dimensional (4D) tensor (C×D×H×W) (e.g., C=1, D=3, H=3, W=3 in FIG. 7). For D=3, the input data 452 may have three frames along the D direction, a frame 452-1, a frame 452-2, and a frame 452-3. Since the PE may process convolution operation for Cvec=3 channels of feature data simultaneously, paddings may be added to each frame of the input data 452 so that each frame may have Cvec number of channels, which is used when transferring data to the PE array for parallel vector operations. All data on the padding channels (e.g., in gray) have a value of zero.

The 3D filter 454 may be used to filter the input data 452, and the 3D filter 454 strides in the directions of the width W, the height H, and the depth D. In FIG. 7, the 3D filter 454 may include a single kernel having two component kernels along the depth T, a component kernel 454-1 at T=1 and a component kernel 454-2 at T=2. The depth T is along the depth D direction. Each component kernel may have a width S (e.g., along X-axis) (S=2), height R (e.g., along Y-axis) (R=2), and the channels C (C=1). Padding (e.g., gray blocks) may be added to each filter of the 3D filter 454 so that each filer may have Cvec number of channels to match the channel vectorization of the input data 452. All data of the padding channels have a value of zero. The PE may process the 3D filter 454 and the input data 452. Since only one PE is used in the convolution operation 450, feature data for the frame 452-1 may be input into the PE separately from other frames (e.g., frame 452-2, frame 452-3) to be processed with the 3D filter 454. The 3D filter 454 may first stride along the direction of width W and the direction of height H on the XY plane, and then along the direction of depth D. For instance, in a stride of the 3D filter 454, the PE may process Cvec channels of input data and filter data from the input data vectorized channel and the filter vectorized channel, respectively, at a time, or per-step. For example, the PE may conceptually superimpose the 3D filter 454 over the input data 452 such that the component kernels 454-1 and 454-2 coincide with the input data of 452-1 and 452-2, respectively. The PE may then compute a dot product of the coinciding vectorized channels and accumulate the results until all dimensions have been considered for the current stride. After the 3D filter 454 has been applied to all dimensions of the input data 452 inside a stride, a flushing signal (e.g., from the sequencer 410) may be used to indicate the end of the stride, and the PE may output the corresponding feature data obtained in the stride. For example, in a stride, the component kernels 454-1 and 454-2 may coincide with the input data inside volumes associated with area 456 (e.g., in XY plane) and area 458 (e.g., in XY plane), respectively. A depth counter may be used to support the loading of the input data for the frame 452-2 (e.g., D=2) and the filter data for the component kernel 454-2 (e.g., T=2) to the PE.

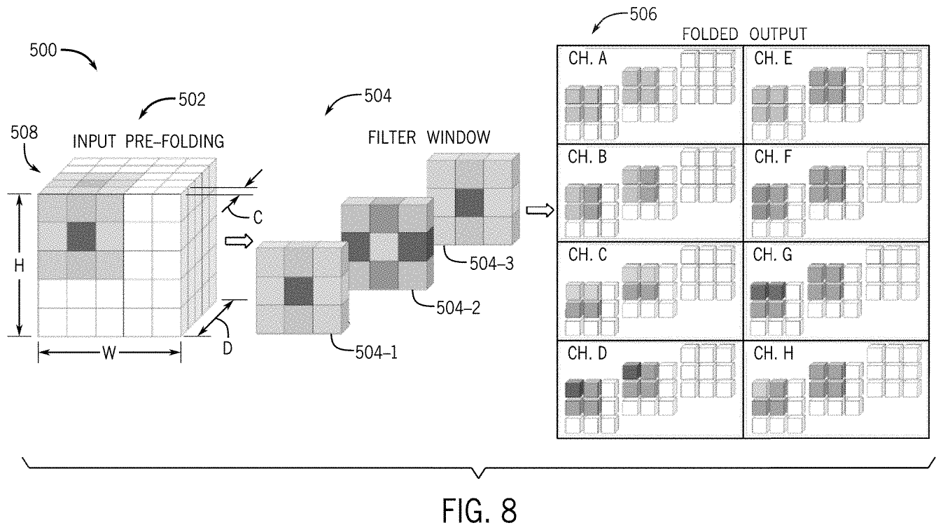

As discussed previously, vectorization may be used to convert sequential data (e.g., data along the depth) into vector implementation in order to use multiple PEs simultaneously in a PE array. Accordingly, when the vectorization channel is larger than the input channel of the input data, the input data may be reshaped by leveraging the filter stride, so that some of the depth, height, or width data may be moved into the vectorization channel. Accordingly, a volume of the input data may be folded into the vectorization channel so that the PE array may be better utilized. FIG. 8 is a block diagram illustrating a 3D data folding process 500. In FIG. 8, input pre-folding data 502 may have dimensions of C×D×H×W, with C=1, D=5, H=5, W=5. A filter window 504, which may include three filters such as 504-1, 504-2, and 504-3, may be used to fold the input pre-folding data 502 into eight types of channels of a vectorization channel, and each type of channel includes three channels to make a total of twenty-four channels in the folded output 506 (e.g., 3 channels of channel A (Ch. A), 3 channels of channel B (Ch. B), 3 channels of channel C (Ch. C), 3 channels of channel D (Ch. D), 3 channels of channel E (Ch. E), 3 channels of channel F (Ch. F), 3 channels of channel G (Ch. G), 3 channels of channel H (Ch. H)). The gray blocks in the folded output 506 are paddings and have values of zero. The number of channels in the folded output 506 may be determined by the strides of the filter window 504. For example, the filter window 504 may stride in the directions of D, H, and W with corresponding stride sizes (e.g., stride_depth, stride_height, stride_width), and the number of channels in the folded output 506 equals to three times the product of the stride sized in the three directions (3×stride_depth×stride_height×stride_width).

For example, in FIG. 8, the stride sizes have the values of stride_depth=stride_height=stride_width=2. FIG. 8 shows a volume 508 (e.g., a 3×3×3 cube) of the input pre-folding data 502 folded into the vectorization channel. For example, input data located in different locations (e.g., depth, width, height) in the volume 508 may be folded into different channels in the folded output 506 based on folding rules. For example, the folding rules may be designed to fold corner blocks (in light blue) of odd layers (e.g., the first layer and the third layer of the volume 508) to Ch. A; the top and bottom center blocks (in cyan) of odd layers (e.g., the first layer and the third layer of the volume 508) to Ch. B; the left edge center and right edge center blocks (in yellow) of odd layers (e.g., the first layer and the third layer of the volume 508) to Ch. C; the center blocks (in brown) of odd layers (e.g., the first layer and the third layer of the volume 508) to Ch. D; the corner blocks (in red) of even layers (e.g., the second layer of the volume 508) to Ch. E; the top and bottom center blocks (in orange) of even layers (e.g., the second layer of the volume 508) to Ch. F; the left edge center and right edge center blocks (in dark blue) of even layers (e.g., the second layer of the volume 508) Ch. G; the center block (in green) of even layers (e.g., the second layer of the volume 508) to Ch. H.

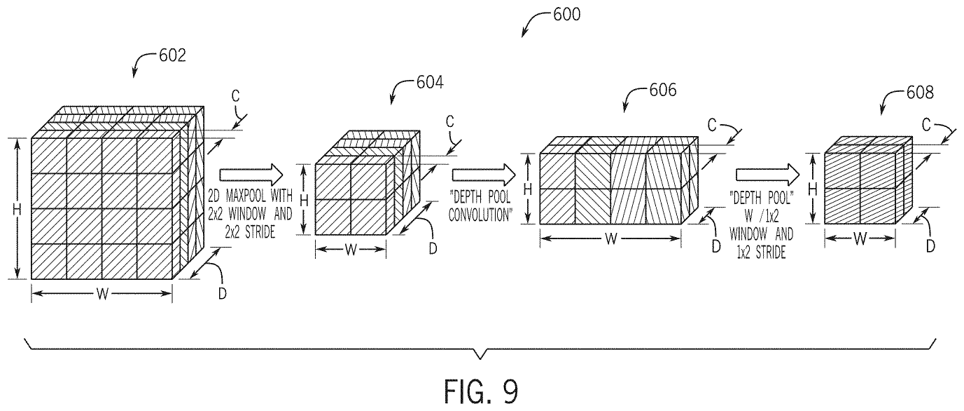

As mentioned previously, in a 3D CNN, 3D average pooling may be converted into a 3D convolution, and the 3D max pooling may be decomposed into two 2D max pooling operations: a surface pooling followed by a depth pooling. The compiler is modified to decompose the 3D max pooling to a 2D max pooling and a depth max pooling. Thus, the 3D max pooling layer is decomposed to a 2D max pooling layer and a depth pooling layer in the compiler, in which the depth is mapped as width to allow the reuse of existing 2D pooling module. FIG. 9 is a block diagram of a 3D max pooling process 600. A feature output data 602 with dimensions (C×D×H×W)=(1×4×4×4) may be reduced to a feature data 604 with dimensions (C×D×H×W)=(1×4×2×2) by using a 2D max pooling with 2×2 window (H×W) and 2×2 stride (H×W). The feature data 604 with dimensions (C×D×H×W)=(1×4×2×2) may be rotated by a depth pool convolution to a feature data 606 with dimensions (C×D×H×W)=(1×2×2×4) so that the channels C of the feature data 604 is mapped as the width (W) of the feature data 606. The feature data 606 with dimensions (C×D×H×W)=(1×2×2×4) may be reduced to a final feature data 608 with dimensions (C×D×H×W)=(1×2×2×2) by using depth pooling with a window size of 1×2 and a stride of 1×2.

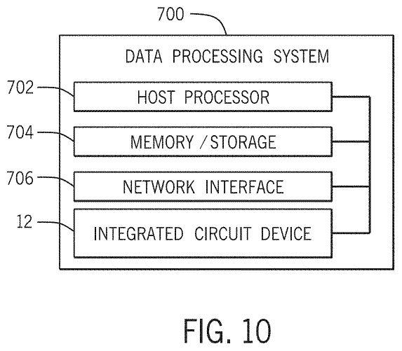

The circuit discussed above may be implemented on the integrated circuit system 12, which may be a component included in a data processing system, such as a data processing system 700, shown in FIG. 10. The data processing system 700 may include the integrated circuit system 12 (e.g., a programmable logic device), a host processor 702, memory and/or storage circuitry 704, and a network interface 706. The data processing system 700 may include more or fewer components (e.g., electronic display, user interface structures, application specific integrated circuits (ASICs)). Moreover, any of the circuit components depicted in FIG. 10 may include the integrated circuit system 12 with the programmable routing bridge. The host processor 702 may include any of the foregoing processors that may manage a data processing request for the data processing system 700 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 704 may include random access memory (RAM), read-only memory (ROM), one or more hard drives, flash memory, or the like. The memory and/or storage circuitry 704 may hold data to be processed by the data processing system 700. In some cases, the memory and/or storage circuitry 704 may also store configuration programs (e.g., bitstreams, mapping function) for programming the integrated circuit system 12. The network interface 706 may allow the data processing system 700 to communicate with other electronic devices. The data processing system 700 may include several different packages or may be contained within a single package on a single package substrate. For example, components of the data processing system 700 may be located on several different packages at one location (e.g., a data center) or multiple locations. For instance, components of the data processing system 700 may be located in separate geographic locations or areas, such as cities, states, or countries.

The data processing system 700 may be part of a data center that processes a variety of different requests. For instance, the data processing system 700 may receive a data processing request via the network interface 706 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. For example, the programmable routing bridge described herein may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

Example Embodiment 1. A device comprising:
a buffer configured to receive feature data from an input feeder, wherein the input feeder comprises a counter; and
a processing element (PE) array configured to:
   receive filter data for a plurality of filters from the input feeder;
   receive a set of feature data from the buffer based on a parameter provided by the counter, wherein the set of feature data comprises a plurality of dimensions, and wherein the parameter is along one of the plurality of dimensions; and
   process a convolution operation using the filter data and the set of feature data, wherein the plurality of filters are configured to stride the set of feature data along each of the plurality of dimensions in the convolution operation.

Example Embodiment 2. The device of example embodiment 1, wherein the plurality of dimensions comprises a temporal dimension.

Example Embodiment 3. The device of example embodiment 1, wherein the plurality of dimensions comprises three spatial dimensions.

Example Embodiment 4. The device of example embodiment 1, wherein the filter data comprises the plurality of dimensions.

Example Embodiment 5. The device of example embodiment 1, wherein the parameter is along a depth dimension of the plurality of dimensions, wherein the depth dimension comprises a temporal dimension or a spatial dimension.

Example Embodiment 6. The device of example embodiment 1, wherein the feature data comprise human actions, or videos, or any combination thereof.

Example Embodiment 7. The device of example embodiment 1 wherein the feature data comprise an object in a three-dimensional (3D) Cartesian coordinate system.

Example Embodiment 8. The device of example embodiment 1, wherein the convolution operation comprises using a three-dimensional (3D) folding method to fold a volume of the set of feature data into a vectorization channel of the PE array.

Example Embodiment 9. The device of example embodiment 1, wherein the convolution operation comprises using a three-dimensional (3D) pooling method to generate feature output for the PE array, wherein the 3D pooling method comprises a 2D pooling and a depth pooling.

Example Embodiment 10. The device of example embodiment 1, wherein the PE array is configurable to send out a result of the convolution operation in response to receiving a signal, wherein the signal is indicative of an end of a stride of the plurality of filters.

Example Embodiment 11. An article of manufacture comprising one or more tangible, non-transitory, machine-readable media storing data that configure a programmable logic device with a system design comprising:
a processing element (PE) array; and
an input feeder comprising a depth counter to feed a plurality of depths of input data to the PE array based on a signal indicative of which depth of the plurality of depths from the depth counter, wherein the input data comprises a plurality of dimensions.

Example Embodiment 12. The article of manufacture of example embodiment 11, wherein the plurality of dimensions comprises a temporal dimension.

Example Embodiment 13. The article of manufacture of example embodiment 11, wherein the plurality of dimensions comprises three spatial dimensions.

Example Embodiment 14. An article of manufacture comprising one or more tangible, non-transitory, machine-readable media storing instructions that, when executed by one or more processors, cause the one or more processors to:
receive a volume of input pre-folding data comprise a plurality of sets of data, wherein the volume of input pre-folding data comprise a plurality of dimensions; and
apply a folding rule to the volume of input pre-folding data to put the plurality of sets of data to a plurality of channels to enable efficient processing by processing element (PE) array.

Example Embodiment 15. The article of manufacture of example embodiment 14, wherein the folding rule comprises putting each set of data of the plurality of sets of data to a corresponding channel of the plurality of channels based on a respective location of each set of data in the volume of input pre-folding data, wherein the respective location is associated with the plurality of dimensions.

Example Embodiment 16. The article of manufacture of example embodiment 14, wherein the input pre-folding data comprise an object in a three-dimensional (3D) Cartesian coordinate system.

Example Embodiment 17. A method comprising:
receiving, by a processing element (PE) array, filter data for a plurality of filters from an input feeder;
receiving, by the processing element (PE) array, a set of feature data from a buffer based on a parameter provided by a counter in the buffer, wherein the set of feature data comprises a plurality of dimensions, and wherein the parameter is along one of the plurality of dimensions; and
processing, by the processing element (PE) array, a convolution operation using the filter data and the set of feature data, wherein the plurality of filters are configured to stride the set of feature data along each of the plurality of dimensions in the convolution operation.

Example Embodiment 18. The method of example embodiment 17, comprising using a three-dimensional (3D) folding method to fold a volume of the set of feature data into a vectorization channel of the PE array.

Example Embodiment 19. The method of example embodiment 17, comprising using a three-dimensional (3D) pooling method to generate feature output for the PE array, wherein the 3D pooling method comprises a 2D pooling and a depth pooling.

Example Embodiment 20. The method of example embodiment 17, comprising sending out a result of the convolution operation in response to receiving a signal, wherein the signal is indicative of an end of a stride of the plurality of filters.

What is claimed is:

1. A device comprising:
a buffer configured to receive feature data from an input feeder, wherein the input feeder comprises a counter; and
a processing element (PE) array configured to:
receive filter data for a plurality of filters from the input feeder;
receive a set of feature data from the buffer based on a parameter provided by the counter, wherein the set of feature data comprises a plurality of dimensions, and wherein the parameter is along one of the plurality of dimensions; and
process a convolution operation using the filter data and the set of feature data, wherein the plurality of filters are configured to stride the set of feature data along each of the plurality of dimensions in the convolution operation.

2. The device of claim 1, wherein the plurality of dimensions comprises a temporal dimension.

3. The device of claim 1, wherein the plurality of dimensions comprises three spatial dimensions.

4. The device of claim 1, wherein the filter data comprises the plurality of dimensions.

5. The device of claim 1, wherein the parameter is along a depth dimension of the plurality of dimensions, wherein the depth dimension comprises a temporal dimension or a spatial dimension.

6. The device of claim 1, wherein the feature data comprise human actions, or videos, or any combination thereof.

7. The device of claim 1 wherein the feature data comprise an object in a three-dimensional (3D) Cartesian coordinate system.

8. The device of claim 1, wherein the convolution operation comprises using a three-dimensional (3D) folding method to fold a volume of the set of feature data into a vectorization channel of the PE array.

9. The device of claim 1, wherein the convolution operation comprises using a three-dimensional (3D) pooling method to generate feature output for the PE array, wherein the 3D pooling method comprises a 2D pooling and a depth pooling.

10. The device of claim 1, wherein the PE array is configurable to send out a result of the convolution operation in response to receiving a signal, wherein the signal is indicative of an end of a stride of the plurality of filters.

11. An article of manufacture comprising one or more tangible, non-transitory, machine-readable media storing data that configure a programmable logic device with a system design comprising:
a processing element (PE) array; and
an input feeder comprising a depth counter to feed a plurality of depths of input data to the PE array based on a signal indicative of which depth of the plurality of depths from the depth counter, wherein the input data comprises a plurality of dimensions.

12. The article of manufacture of claim 11, wherein the plurality of dimensions comprises a temporal dimension.

13. The article of manufacture of claim 11, wherein the plurality of dimensions comprises three spatial dimensions.

14. An article of manufacture comprising one or more tangible, non-transitory, machine-readable media storing instructions that, when executed by one or more processors, cause the one or more processors to:
receive a volume of input pre-folding data comprise a plurality of sets of data, wherein the volume of input pre-folding data comprise a plurality of dimensions; and
apply a folding rule to the volume of input pre-folding data to put the plurality of sets of data to a plurality of channels to enable efficient processing by processing element (PE) array.

15. The article of manufacture of claim 14, wherein the folding rule comprises putting each set of data of the plurality of sets of data to a corresponding channel of the plurality of channels based on a respective location of each set of data in the volume of input pre-folding data, wherein the respective location is associated with the plurality of dimensions.

16. The article of manufacture of claim 14, wherein the input pre-folding data comprise an object in a three-dimensional (3D) Cartesian coordinate system.

17. A method comprising:
receiving, by a processing element (PE) array, filter data for a plurality of filters from an input feeder;
receiving, by the processing element (PE) array, a set of feature data from a buffer based on a parameter provided by a counter in the buffer, wherein the set of feature data comprises a plurality of dimensions, and wherein the parameter is along one of the plurality of dimensions; and
processing, by the processing element (PE) array, a convolution operation using the filter data and the set of feature data, wherein the plurality of filters are configured to stride the set of feature data along each of the plurality of dimensions in the convolution operation.

18. The method of claim 17, comprising using a three-dimensional (3D) folding method to fold a volume of the set of feature data into a vectorization channel of the PE array.

19. The method of claim 17, comprising using a three-dimensional (3D) pooling method to generate feature output for the PE array, wherein the 3D pooling method comprises a 2D pooling and a depth pooling.

20. The method of claim 17, comprising sending out a result of the convolution operation in response to receiving a signal, wherein the signal is indicative of an end of a stride of the plurality of filters.
